(19) United States
(12) Patent Application Publication
(10) Pub. No.: US 2020/0029173 A1
(43) Pub. Date: Jan. 23, 2020

(54) METHOD FOR RECORDING ATTENDANCE USING BLUETOOTH ENABLED MOBILE DEVICES

(71) Applicant: Timetec Holding Sdn Bhd, PUCHONG (MY)

(72) Inventors: KOK LOONG PANG, Puchong (MY); YUAN YEW CHOO, Puchong (MY)

(73) Assignee: Timetec Holding Sdn Bhd, PUCHONG (MY)

(21) Appl. No.: 16/401,398

(22) Filed: May 2, 2019

(30) Foreign Application Priority Data
Jul. 20, 2018 (MY) PI 2018702542

(51) Int. Cl. H04W 4/029; H04W 4/80; H04W 40/24; H04W 76/11; H04W 4/02; G01S 5/00

(52) U.S. Cl. CPC H04W 4/029; H04W 4/80; G01S 5/0027; H04W 76/11; H04W 4/025; H04W 40/244

(57) ABSTRACT

A method for recording attendance using BLUETOOTH-enabled mobile devices comprising the steps in the sequence set forth: triggering (104, 105), by a logged-in user, a respective mobile device to detect for surrounding BLUETOOTH beacons, wherein different user account each is assigned with their respective list of BLUETOOTH beacons for triggering the attendance recording; comparing (106), by the respective mobile device, the detected list of BLUETOOTH beacons with the assigned list of BLUETOOTH beacons of the corresponding user account and only retrieves one or more BLUETOOTH beacon IDs from BLUETOOTH beacons that are assigned to the corresponding user account; and forwarding (107), by the respective mobile device, the retrieved BLUETOOTH beacon ID(s) together with a retrieval timestamp to an administrator server for generating an attendance record.

### CROSS-REFERENCE TO RELATED APPLICATION

The instant application claims priority to Malaysian Patent Application Serial No. PI 2018702542 filed Jul. 20, 2018, the entire specification of which is expressly incorporated herein by reference.

### FIELD OF THE INVENTION

The invention relates to an attendance recording method. More particularly, the invention relates to an attendance recording method using BLUETOOTH-enabled mobile devices.

### BACKGROUND OF THE INVENTION

Attendance taking is a common task being performed every day in the workplace or in academia such as schools and universities. Traditionally, attendance are taken in a conventional method of calling names and signing of attendance sheet during classes or having a time card punching system to record the time-in and time-out of employees in a workplace. These old methods have proven to be very tedious especially when recording a big group of attendees. Further, fraudulent of attendance are often happened as the time sheet can be easily manipulated. On the other hand, implementation of digital attendance system by having biometric employee time clocks or face recognition had limited the mobility of the system as mostly of these devices are being fixed at a location which is not able to track the real-time location of the employees. This is crucial especially when the employees involve in outdoor activities during working hour such as sales and marketing.

In one example as shown in patent document CN102254357. This patent discloses a attendance system which comprises a wireless attendance terminal and an attendance system management control platform, wherein a mobile phone platform is used as the wireless attendance terminal which is used for receiving and uploading attendance data; and the attendance system management control platform is used for receiving the attendance information above and then generating attendance results. The drawback of this patent is that the location of the attendance being taken may not be accurate as it is being proximately detected from an electronic map.

Besides, another patent document CN103426208 also provides a cell phone attendance system based on WiFi signals. According to the system, SSID identification information of a WiFi signal source of a space where an employee is located is collected through a smart cell phone of the employee, then the information is sent back to a server, pre-stored SSID identification information of the WiFi signal source of the space where the employee is located are compared by the server, therefore whether the employee holding the cell phone arrives at a specific attendance position is determined, and attendance is completed. However, the WiFi signals may be weaken not connectable when a large group of users are connected to the same WiFi signal.

Further, KR 101642818 also discloses an attendance system using Wi-Fi beacon signal. The system functions on the basis of the beacon signal transmitted from Wi-Fi access point and connect to the Wi-Fi access points and participants of the mobile terminal asynchronously, to monitor the connection status of the participants of the mobile terminal for the Wi-Fi access points in real time, the attendance system also further including a control unit. However, the installation of Wi-Fi access points requires skilled person and also requires a power station.

To summarize, it desirable to enhance the existing system or method which is able to overcome the above-mentioned drawbacks. This invention provides such a method.

### SUMMARY OF THE INVENTION

The objective of this invention is to provide a method for recording attendance using BLUETOOTH-enabled mobile devices comprising the steps in the sequence set forth of triggering a respective mobile device to detect for surrounding BLUETOOTH beacons by a logged-in user, comparing the detected list of BLUETOOTH beacons with the assigned list of BLUETOOTH beacons of the corresponding user account by the respective mobile device and forwarding the retrieved BLUETOOTH beacon ID(s) together with a retrieval timestamp to an administrator server for generating an attendance record by the respective mobile device.

By BLUETOOTH, as that term s used herein, it is meant to include, without limitation, any wireless technology standard for exchanging data over short distances (e.g., using short-wavelength UHF radio waves in the ISM band from 2.4 to 2.485 GHz) from fixed and mobile telecommunication devices, and building personal area networks (PANS).

Preferably, each of the different user account is assigned with their respective list of BLUETOOTH beacons for BLUETOOTH beacons for triggering the attendance recording.

Preferably, the method further includes the step of verifying the identification of the user through image captured from the mobile device by the administrator server via the respective mobile device.

Preferably, the method further includes the step of verifying the location of the generated attendance record through GPS coordination detected form the mobile device by the administrator server.

Preferably, the method further includes the step of verifying the received attendance record from the mobile device through comparison with a pre-stored data within the administrator server.

Preferably, the method further includes the step of generating an attendance report of the user based on the received and verified attendance report by the administrator server.

One skilled in the art will readily appreciate that the invention is well adapted to carry out the objects and obtain the ends and advantages mentioned, as well as those inherent therein. The embodiments described herein are not intended as limitations on the scope of the invention.

### BRIEF DESCRIPTION OF THE DRAWINGS

For the purpose of facilitating an understanding of the invention, there is illustrated in the accompanying drawings the preferred embodiments from an inspection of which when considered in connection with the following description, the invention, its construction and operation and many of its advantages would be readily understood and appreciated.

FIG. 1 is a flowchart illustrating the flow of recording attendance using BLUETOOTH-enabled mobile devices.

FIG. 2 is a flowchart illustrating the flow of tracking a patrolling checkpoint.

### DETAILED DESCRIPTION OF THE INVENTION

The invention will now be described in greater detail, by way of example, with reference to the drawings.

The present invention discloses a method to be implemented in a system for recording attendance. The system comprises a plurality of BLUETOOTH-enabled mobile devices, a plurality of BLUETOOTH beacons and an administrator server. The BLUETOOTH-enabled mobile devices, in one embodiment, may be implemented using any appropriate combination of hardware and/or software configured for wireless communication over network. For example, the mobile devices may be implemented as a wireless telephone, smart phone, tablet, personal digital assistant (PDA), or other wearable computing devices which is able to establish BLUETOOTH and wireless network connection between the BLUETOOTH Beacons and the administrator server.

The mobile devices may include, but not limited to, any appropriate combination of hardware and/or software having one or more processors and capable of reading instructions stored in a tangible non-transitory machine-readable medium for execution by one or more processors. Consistent with some embodiments, the mobile devices include a machine-readable medium, such as a memory that includes instructions for execution by one or more processors for causing the mobile devices to perform specific tasks. In some embodiments, the instructions may be executed by one or more processors in response to interaction by users. For example, such instruction may include a mobile application, which provides a user interface to permit user to communicate with the administrator server for attendance recording at a timestamp. The mobile application may include a graphical user interface (GUI) that is configured to allow user to interface and communicate with the administrator server via a network.

In some embodiments, the mobile devices may further include a location component for determining a location of the mobile device. The location component may correspond to a GPS transceiver that is in communication with one or more GPS satellites. In other embodiments, location component may be configured to determine a location of the mobile devices by using an internet protocol (IP) address lookup, or by triangulating a position based on nearby telecommunications towers or wireless access points (WAPs). Location component may be further configured to store a user-defined location in a memory component that can be transmitted to a third party for the purpose of identifying a location of the mobile devices.

In some embodiments, the mobile devices also further includes sensor component that captures information related to the user that may be associated with any actions that user perform using the mobile devices. Such sensor component may includes camera and imaging component, accelerometers, biometric readers, GPS devices, motion capture devices, and other devices that are capable of providing information about the mobile devices or the user, or an environment there around. Further, the mobile devices may also include one or more wireless transceivers that may each include an antenna that is separable or integral and is capable of transmitting and receiving information according to one or more wireless network protocols, such as Wi-Fi, 3G, 4G, HSDPA, LTE, RF, NFC, IEEE, BLUETOOTH, BLE, WiMAX, ZigBee and/or any combination thereof.

The network, in one embodiment, may be implemented as a single network or a combination of multiple networks. For instance, in various embodiments, the network may include but not limit to Internet and/or one or more intranets, landline networks, wireless networks, and/or other appropriated types of communication network. In another example, the network may include a wireless telecommunications network such as cellular phone network adapted to communicate with other communication networks, such as Internet.

In some embodiments, the beacons may be installed at a premise location, such as a store, restaurant, offices, patrolling checkpoints, a bus stop, a room or a more specific location where the user's attendance is to be recorded. In some embodiments, the beacons may be BLUETOOTH Low Energy (BLE) beacons in which broadcast their identifier to nearby portable electronic devices. The beacons may transmit one or more sequences of information such that when the mobiles devices capable of receiving information from the beacons comes within the range of a beacon, the mobile devices may receive a transmission from a beacon that may include information, data, metadata and/or the combination thereof that may be displayed by the mobile devices or used by the mobile devices. On the other hand, the beacon may also transmit information to the plurality of mobile devices using other wireless communication protocols, such as Near Field Communications (NFC), Radio Frequency Identification (RFID) or the combination thereof.

In some embodiments, the beacons may also include a power source. The power source may be any power source capable to provide sufficient current to power the components of beacon. In some embodiments, power source may be a battery, such as a watch battery or button cell. In some embodiments, the beacons may be a portable device that is configured to be plugged into an electrical socket to create a temporary BLUETOOTH beacon at that electrical socket.

In some embodiments, the administrator server includes a computing device which may correspond to the mobile devices. The computing device may be a mobile device such as a personal computer, laptop computer, netbook, or tablet computer or other devices which would be able to control and configure the settings of the administrator server. The computing device includes a network-interface component (NIC) configured for communication with a network. Further, the computing device may also includes a wireless communication component, such as a wireless broadband component, a wireless satellite component, or various type of wireless communication components including radio frequency (RF), microwave frequency (MWF), and/or infrared (IR) component configured for communication with network. Consistent with other embodiments, NIC may be configured to interact with a coaxial cable, a fibre optic cable, a digital subscriber line (DSL) modem, a public switched telephone network (PSTN) modem, an Ethernet device, and/or various types of wired and wireless network communication devices adapted for communication with the network. The administrator server may further include at least one database for storing user accounts credentials. The database may be but not limit to a memory component such as a random access memory (RAM), an internal memory component, a read-only memory (ROM), or an external or static optical, magnetic, or solid-state memory.

Consistent with some embodiments, the computing device further includes a display component for displaying information to a user of the administrator server. Preferably, the display component may be but not limit to a liquid crystal display (LCD) screen, an organic light emitting diode (OLED) screen, an LED screen, a plasma display, or a cathode ray tube (CRT) display. Further, the computing device also includes an input component for allowing a user to input information into the administrator server. Such information may includes user's accounts ID, list of configured beacons and its assigned locations, list of allowed clock-in beacon's ID for a user and/or the combination thereof. The input component may include, for example, a keyboard or key pad, whether physical or virtual. Consistent with some embodiments, the computing device may also include navigation control component such as mouse, trackball or the like. Moreover, if the computing device includes a touch screen, display component, input component and navigation control component may be a single integrated component, such as a capacitive sensor-based touch screen.

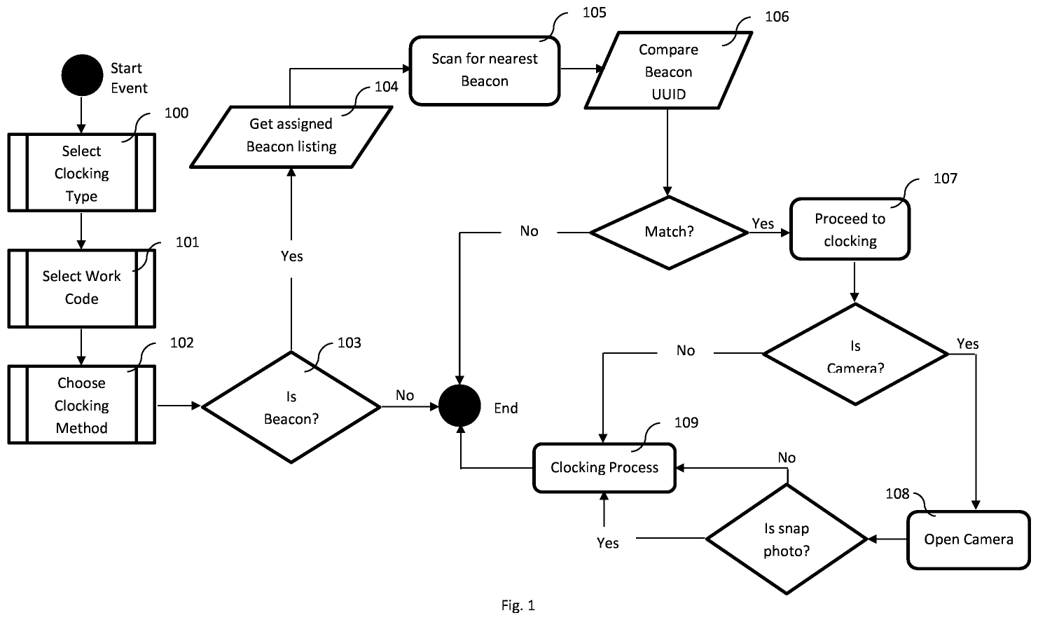

FIG. 1 shows a flow chart illustrating the method for recording attendance using BLUETOOTH-enabled mobile devices. The method comprising the steps of logging into a user account via a mobile device application for selecting a clocking type as shown in step 100. The clocking type may include clock-in, clock-out, and/or the combination thereof. In step 101, the user is prompted to select a corresponded work code within the mobile device application. Preferably, the work code defines the nature of work carried out by the user, in which the work code may be defined as a numerical code, alphabetical code, and/or the combination thereof. Next, in step 102, the user is allowed to choose a clocking method via the user interface of the mobile device application. The clocking method may include manual clocking by keying in related details such as location of work, time-in, time-out, duration of work, and/or the combination thereof.

In a preferred embodiment, the clocking method may also include automatic clocking when a BLUETOOTH beacon is present in within a proximity distance as shown in step 103. Consistent with some embodiments, the respective mobile communicates with the administrator server for receiving a list of assigned BLUETOOTH beacons' ID respective to the logged-in user's account as illustrated in step 104. The respective mobile device of a logged-in user triggers the detection of surrounding BLUETOOTH beacons that is present within a range in step 105. Further in step 106, the respective mobile device compares the detected list of BLUETOOTH beacons with the assigned list of BLUETOOTH beacons of the corresponding user account and only retrieves one or more BLUETOOTH beacon IDs from BLUETOOTH beacons that are assigned to the corresponding user account. Moving on to step 107 and 109, the respective mobile device forwards the retrieved BLUETOOTH beacon ID(s) together with a retrieval timestamp to the administrator server to attendance record generation.

In some embodiments, the method may further includes the step of verifying the identification of user through image captured from the mobile device by the administrator server via the respective mobile device as shown in step 108. However, it should be understood that the verification of user's identification shall also include information such as real time GPS coordination, biometric information, and/or the combination thereof detected from the mobile device. In some embodiments, the administrator server further generates an attendance report of the respective user based on the received and verified attendances records.

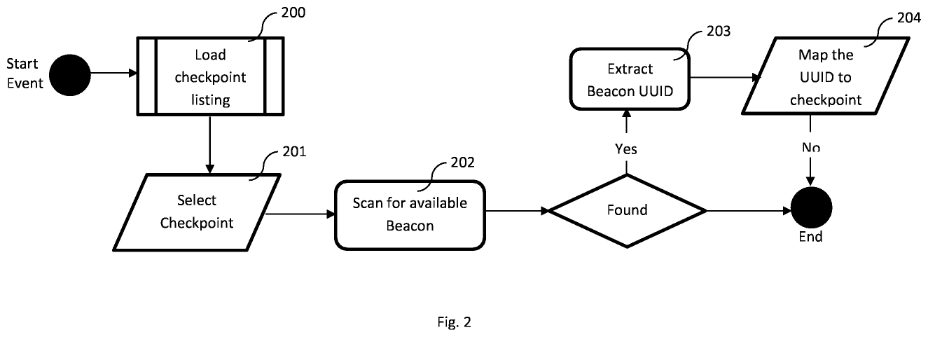

In another preferred embodiment as shown in FIG. 2, the method can be applied for tracking a patrolling checkpoint. The method initiates with step 200 whereby the logged-in user mobile device communicates with the administrator server for receiving a plurality of available checkpoint listing for the corresponded user account. In step 201, the user is allowed to select a checkpoint that is received and stored within the mobile device. Moving on in step 202, the mobile device will scan and search for available BLUETOOTH beacon UUID when the user is present within the proximity range of the available checkpoint. In step 203 and 204, the available BLUETOOTH beacon UUID is then extracted and further mapped with the checkpoint's location for verification to generate a record of attendance. Preferably, the generated attendance record is transmitted to the administrator server over a communication network for verification and storing.

The present disclosure includes as contained in the appended claims, as well as that of the foregoing description. Although this invention has been described in its preferred form with a degree of particularity, it is understood that the present disclosure of the preferred form has been made only by way of example and that numerous changes in the details of construction and the combination and arrangements of parts may be resorted to without departing from the scope of the invention.

What is claimed is:

1. A method for recording attendance using BLUETOOTH-enabled mobile devices, comprising the steps of:
triggering, by a logged-in user, a respective mobile device to detect for surrounding BLUETOOTH beacons, wherein different user account each is assigned with their respective list of BLUETOOTH beacons for triggering the attendance recording;
comparing, by the respective mobile device, the detected list of BLUETOOTH beacons with the assigned list of BLUETOOTH beacons of the corresponding user account and only retrieves one or more BLUETOOTH beacon IDs from BLUETOOTH beacons that are assigned to the corresponding user account; and
forwarding, by the respective mobile device, the retrieved BLUETOOTH beacon ID(s) together with a retrieval timestamp to an administrator server for generating an attendance record.

2. The method as claimed in claim 1, further comprising the step of verifying (108), by the administrator server via the respective mobile device, the identification of the user through image captured from the mobile device.

3. The method as claimed in claim 2, further comprising the step of verifying, by the administrator server via the respective mobile device, the location of the generated attendance record through GPS coordination detected from the mobile device.

4. The method as claimed in claim 3, further comprising the step of verifying, by the administrator server, the received attendance record from the mobile device through comparison with a pre-stored data within the administrator server.

5. The method as claimed in claim 4, further comprising the step of generating, by the administrator server, an attendance report of the user based on the received and verified attendance records.
